(19) United States
(12) Patent Application Publication
(10) Pub. No.: US 2020/0155968 A1
(43) Pub. Date: May 21, 2020

(54) UNIVERSAL SEPARATOR SYSTEM AND METHOD

(71) Applicant: Peter Stang, Edmonton (CA)

(72) Inventor: Peter Stang, Edmonton (CA)

(21) Appl. No.: 16/565,629

(22) Filed: Sep. 10, 2019

Related U.S. Application Data
(63) Continuation-in-part of application No. 16/204,537, filed on Nov. 29, 2018, now abandoned.

(30) Foreign Application Priority Data
Nov. 15, 2018 (CA) 3024237

(51) Int. Cl. B01D 17/04; B01D 17/06; B01D 21/26

(52) U.S. Cl. CPC B01D 17/045; B01D 17/041; B01D 17/047; B01D 2221/06; B01D 21/267; B01D 2221/04; B01D 17/06

(57) ABSTRACT

The universal separator is a device that provides simultaneous separation of solids and oils (and potentially gases) from water. It has applications in many industries including: Sewage Treatment; Water Treatment; Oil & Gas (tailings ponds, SAGD, etc.); Mining; and Food Processing. Furthermore, the concept offers virtually endless operating and geometric variations depending on the application. The universal separator employs various means of separation including coagulation, cyclonic separation, recycling, electrostatic demulsification and oil floatation.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of liquid purification or separation of existing art and more specifically relates to cyclonic, or centrifugal liquid purification or separation, via a universal separator system.

### RELATED ART

Separation of solids and oils from water is required in many industries. Current separation methods include: gravity separation, cyclones, filtration, membranes and fabrics and centrifuges. Separators can be designed to treat a variety of contaminants in water including free floating oil, emulsified oil, and suspended solids. Not all separator types are capable of separating both solids and oils. The most common performance parameters considered are: oil and solid separation efficiency and the discharge water quality desired.

Gravity separators require large holding tanks or ponds and also require long holding periods. Cyclones may perform well when there is significant density difference between the solids and liquids. Filtration, membranes and fabrics may limit flow and often require high levels of maintenance. Centrifuges require high capital, operating and maintenance costs. Thus, it is desirable to have a reliable, cost-effective, and safe means to separate solids and oils from water.

### SUMMARY OF THE INVENTION

In view of the foregoing disadvantages inherent in the known liquid purification or separation art, the present disclosure provides a novel universal separator. The general purpose of the present disclosure, which will be described subsequently in greater detail, is to provide an efficient and effective means for separation of solids and oils from water in a simultaneous fashion.

The universal separator is a device that provides simultaneous separation of solids and oils (and even gases) from water, or by simplifying the unit it provides separation of solids only. It has applications in many industries including the following: Sewage Treatment; Water Treatment; Oil & Gas (produced water, tailings ponds, SAGD, oil spill cleanup, etc.); Mining; and Food Processing. Furthermore, the concept offers virtually endless operating and geometric variations (for optimum performance) depending on the application. The universal separator employs various means of separation including coagulation, cyclonic separation, recycling, electrostatic and chemical demulsification and oil floatation. It may offer significant advantages over current separation methods as follows: 1) Low initial investment; 2) Superior performance; 3) Simple, automatic operation and low maintenance; 4) Modular construction of operational units; and 5) Many additional advantages for various applications such as Sewage Treatment.

A universal separator is disclosed herein, in a preferred embodiment comprising: a vessel, an inlet flow chamber partially separated from the main body of the vessel with two inlet flow connections, and an underflow outlet at the bottom of the unit connected to a solids collection chamber. The system further comprises rotating baffles driven by a shaft which passes through the top of the unit, driven by an electric motor supported above the vessel, an oil separation chamber with two conical electrostatic grids; a tangential water outlet connection and an oil outlet connection; connected control valves; an inlet pump, a solids discharge pump, guide bearings and stationary baffles. The universal separator, by use of cyclone separation, electrostatic fields from electrostatic grids (via a DC or AC current generator), induced flow modification and an injected polymer (or polyelectrolyte) provides improved separation of solids and oils.

The universal separator may be described as a modified cyclone with the following additional features intended to contribute to enhanced performance for the separation of oils and solids from water.

The first feature is an inlet zone where the inlet flow enters the unit via two tangential inlet connections 180 degrees apart. These connections reduce the turbulence at the inlet and allow the solids to migrate to the outer wall of the cyclone prior to entering the main body of the unit.

The second and key feature of the unit is a set of enclosed rotating baffles driven by an electric motor mounted on top of the unit. These rotating baffles deliver the following results: a) cause liquid flows that spiral back toward the bottom of the unit (note that these recycle flows move in a parallel fashion to the inlet flows as they descend toward the bottom of the unit); b) pull an oil-water mixture to the top of the unit for separation of the oil from the water.

A third feature is comprised of electrostatic oil-water separation grids located inside of two concentric cones.

A method of use for the universal separator is also described herein.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a universal separator, constructed and operative according to the teachings of the present disclosure.

FIG. 1 is a cut-away side view of the universal separator during an ‘in-use’ condition, according to an embodiment of the disclosure;

FIG. 1A is a 3-dimensional perspective view of the universal separator of FIG. 1; and

FIG. 2 is a process view of controls of the universal separator of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to liquid purification or separation and more particularly to a universal separator as used to improve the separation of solids and oils from water via a cyclone with an inserted rotating baffle chamber. The universal separator employs various means of separation including coagulation, cyclonic separation, recycling, oil flotation and demulsification by polymer injection and an electrostatic field.

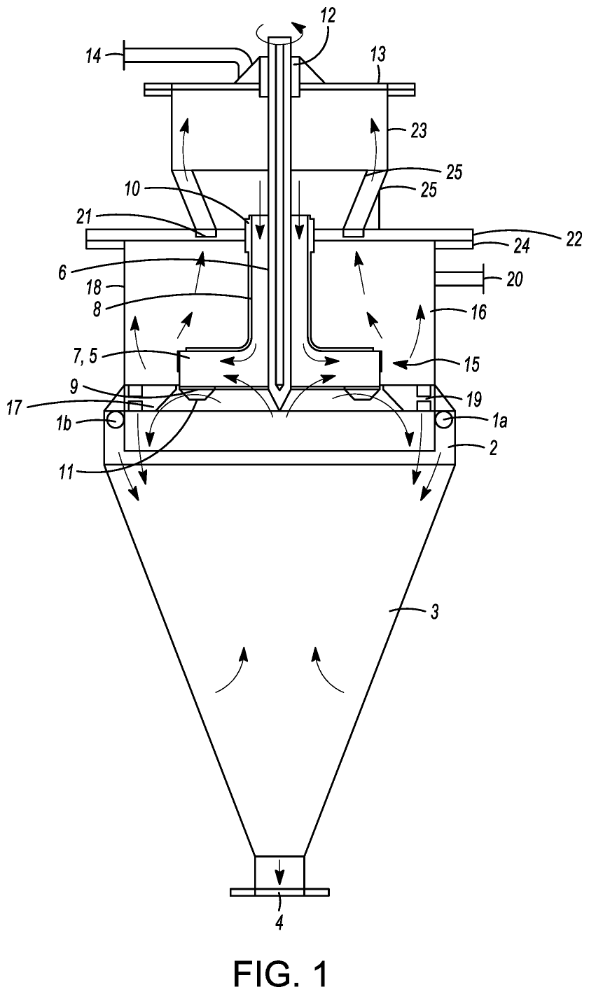

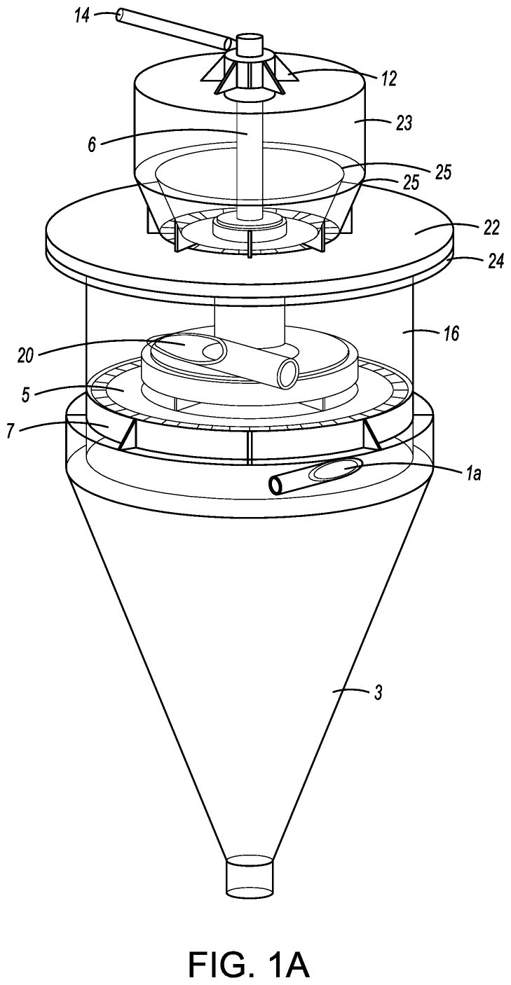

Generally referring now to the present invention as shown in FIG. 1: Flow arrows as shown indicate the directional movement of the rotating flow.

Referring now more specifically to the drawings by numerals of reference, there is shown in FIGS. 1, 1A &2, various views of a universal separator 100.

FIG. 1 shows a universal separator 100, according to an embodiment of the present disclosure. Here, the universal separator 100 may be beneficial for use by a user to promote the thorough separation of solids and oils from water. As illustrated, the universal separator 100 may include a universal separator as a vessel having an inlet chamber; inlet connections; a central axle; a plurality of baffles; and electrostatic grids; wherein the unit functions by use of an electric field created by electrostatic grids connected to a DC or AC current source. A polymer or a polyelectrolyte may be injected into the liquid causing a water-oil emulsion to demulsify and oil and water to separate. Those with ordinary skill in the art will now appreciate that upon reading this specification and by their understanding the art of use of electric fields, as described herein, and methods of liquid separation will be understood by those knowledgeable in such art.

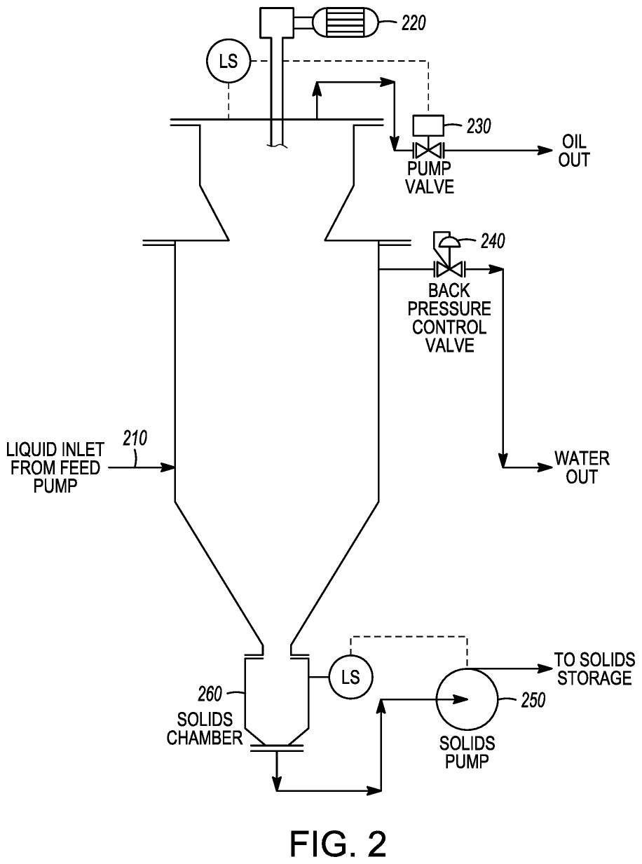

The universal separator's mode of operation for the separation of oils and solids from water is described herein referring specifically to FIGS. 1 & 1A with references to FIG. 2.

Start Up Phase: Before water containing solid particles and oil is introduced into the universal separator, the unit is filled with clean water. The electric motor at the top of the unit starts turning the rotating baffles until it reaches a predetermined rotating speed.

Polymer Injection Phase: After the rotation reaches operating speed, the liquid to be treated is pumped into the unit by a feed pump. Prior to the liquid entering the unit, a chemical agent such as a polymer or a polyelectrolyte may be injected into the inlet flow for the following purposes: 1) it causes the merging of solid particles, making them easier to separate (Stokes Law); 2) it contributes to drag reduction of boundary layers in the cyclone; 3) it promotes demulsification for oil separation.

Referring now to the Inlet flow as shown in FIG. 1. The water, oil and solid mixture enters the unit at two tangential inlet connections (1a & 1b located 180 degrees apart) in the confined space of the inlet chamber 2, establishing a balanced, rotating cyclone flow at the outer wall of the unit.

The liquid exits the bottom of the inlet chamber 2 and enters the cyclone chamber 3. At this point, recycle flows formed from downward spiraling currents from above flow in a parallel fashion inside of the inlet stream. These recycle flows form a layer between the inlet flow and the turbulent flows at the center of the unit allowing the solids at the cone wall to move further down the cone undisturbed. The solids slide to the bottom and exit the cyclone chamber 3 to a solids chamber 4 below. The solid sludge is then pumped out of the solids chamber 4 by an external pump.

The flow rises up the center of the cyclone chamber 3 until it reaches rotating baffle chamber 5. This chamber consists of a central axle 6 and four (4) rotating baffles 7 connected to it at ninety-degree angles, an enclosure 8, a baffle support ring 9 and recycle baffles 11 below the baffle support ring. Note that the rotating baffle chamber 5 is driven by an electric motor mounted above the unit. The axle 6 for the baffle chamber 5 passes through a seal bearing 12 mounted on the enclosing blind flange 13 on top of the separator.

As the rising flow enters the baffle chamber 5, it merges with a downward moving recycle flow coming from the oil separation chamber 23 above. The liquid then moves radially outward toward the perimeter and through the opening 15 into the water chamber 16.

Upon exiting opening 15, the liquid travels outward over stationary baffle support ring 17 attached to the outer wall 18 of the water chamber 16. Part of the flow passes through stationary baffles 19 and recycles back to the bottom of the unit. The balance of the flow circulates to a tangential pipe discharge connection 20 and exits the unit or it continues to rise to the oil separation chamber 23.

The oil-rich water rising up the inner portion of the water chamber 16 passes through openings 21 in flange 22 and into oil separation chamber 23. A second guide bearing 10 for the rotating baffle chamber 5 is connected to flange 22. The oil-water mixture then passes between two cones 25 containing electrostatic grids and into the oil separation chamber 23 where the oil accumulates at the top and flows through an oil discharge connection 14 on top of the vessel. Water in oil separation chamber 23 recycles back down the center of the unit through the baffle chamber 5.

Returning to the flow that rises up the center of the cyclone chamber 3 to the rotating baffles. Part of this flow passes through the recycle baffles 11 and under the baffle support ring 9 to form a second recycle flow to the bottom of the cone. The combined recycle flows form a barrier between the inlet flow and the turbulent flow at the center of the unit. This results in improved separation of solids.

Notably, as an alternative embodiment, the universal separator 100 may be converted into a solids-only separation unit via replacement of the oil separation chamber 23 with a blind flange and bearing to permit operation without exchanging or replacing any other parts.

Referring generally now to FIG. 2 showing various views of the controls of universal separator 100 of FIG. 1, according to an embodiment of the present disclosure.

Control of the universal separator 100 is completely automatic as follows: The drive motor 220 on the top of the unit starts and brings the rotating section up to a predetermined speed. A permissive signal is sent back to the Liquid Feed Pump 210 and it starts pumping liquid into the unit. A self-contained back pressure valve 230 on the clear water outlet line controls the pressure and the water flow out of the unit. A dump valve 240 triggered by an oil-water interface level switch (LS) dumps oil from the top of the vessel to an external storage tank. A solids pump 250 triggered by a level switch (LS), pumps solids out of a solids chamber 260 at the bottom of the unit. No other controls are necessary in preferred embodiments.

It should be noted that a portion of the steps may be optional step(s) and may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for separation are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A universal separator for separation of solids and oils from a liquid, comprising:
a vessel having
a cyclone chamber;
a pair of inlet connections operative to deliver the liquid to the cyclone chamber;
a baffle chamber coupled above the cyclone chamber, the baffle chamber including a plurality of baffles both rotating and stationary;
a water chamber coupled to and surrounding the baffle chamber;
an oil separation chamber coupled above the water chamber, the coupling including a set of conical electrostatic grids and;
a solids collection chamber coupled below the cyclone chamber;
wherein said universal separator by use of an electric field created by the electrostatic grids via either DC or AC current causes oil and water to separate from the liquid.

2. The universal separator of claim 1, wherein the oil exits the oil separation chamber via an oil discharge connection at a higher plane than said water exits.

3. The universal separator of claim 1, wherein an inside surface of the water chamber is coated with an oleophobic material.

4. The universal separator of claim 1, wherein clear water spirals upward and flows out of a tangential water outlet connection with a self-contained back-pressure valve operative to control pressure inside of the universal separator.

5. The universal separator of claim 1, further comprising a feed-pump that moves liquid into the unit.

6. The universal separator of claim 1, further comprising an electric motor that drives said rotating baffles.

7. The universal separator of claim 1, further comprising a chemical agent that is injected into the liquid prior to entering the unit, to cause a water-oil emulsion to demulsify and further causes the merging of solid particles to enhance solids separation.

8. The universal separator of claim 7, wherein the chemical agent is one of: a polymer and a polyelectrolyte.

9. The universal separator of claim 1, wherein said pair of inlet connections are located 180 degrees apart.

10. The universal separator of claim 1, wherein the oil separation chamber is replaced with a blind flange and bearing operative to convert the universal separator into a solids-only separation unit.

11. A method of separating solids and oils from a liquid via a universal separator, the method comprising:
pumping the liquid into a cyclone chamber within the universal separator via a pair of inlet connections
collecting removed solids from the liquid in a solids collection chamber coupled below the cyclone chamber
forcing said liquid, with solids removed, through a plurality of rotating baffles within a baffle chamber situated above the cyclone chamber;
further flowing said liquid into a water chamber surrounding said baffle chamber;
passing said liquid through a set of conical electrostatic grids into an oil separation chamber coupled above said water chamber;
wherein use of an electric field created by the electrostatic grids via either DC or AC current causes oil and water to demulsify and enhance separation of oils from the liquid.

12. The method of claim 11, further comprising removing oil from the oil separation chamber.

13. The method of claim 11, wherein water within the oil separation chamber is recycled through said baffle chamber back into said water chamber.

14. The method of claim 11, wherein the water that is recycled back to said cyclone chamber forms a barrier between the liquid entering the unit and the liquid at the center of said cyclone chamber.

15. The method of claim 11, further comprising injecting a chemical agent into the liquid prior to the liquid entering into the cyclone chamber to cause a water-oil emulsion to demulsify and further causes the merging of solid particles to enhance solids separation.

16. The method of claim 15, wherein the chemical agent is one of: a polymer and a polyelectrolyte.

17. The method of claim 11, wherein the pair of inlet connections are located 180 degrees apart.

18. The method of claim 11, further comprising converting the universal separator into a solids-only separator by replacing the oil separation chamber with a blind flange and bearing.
